(19) United States
(12) Patent Application Publication
(10) Pub. No.: US 2024/0201661 A1
(43) Pub. Date: Jun. 20, 2024

(54) PIPELINE CONTROL SYSTEM

(71) Applicant: Saudi Arabian Oil Company, Dhahran (SA)

(72) Inventors: Hyun Kil Kim, Surrey (CA); Ashiff Khan, Dhahran (SA); Mustafa A. Jubran, Saihat (SA); Mazen A. Zahrani, Dammam (SA)

(21) Appl. No.: 18/081,455

(22) Filed: Dec. 14, 2022

(51) Int. Cl. G05B 19/416

(52) U.S. Cl. CPC G05B 19/416; G05B 2219/37371

(57) ABSTRACT

Disclosed are methods, systems, and computer-readable medium to perform operations including: calculating a rate of flow change per minute in a pipeline of the hydrocarbon production system; determining that the rate of flow change is at least ten percent greater than a predetermined flow change threshold; based on a difference between the rate of flow change and the predetermined flow change threshold, triggering one of a high alarm workflow, a high-high alarm workflow, and a high-high-high alarm workflow; detecting, using the triggered one of the high alarm workflow, the high-high alarm workflow, and the high-high-high alarm workflow, a potential or actual break in the pipeline; and in response, performing a corrective action to avoid the potential break or mitigate the actual break in the pipeline.

### TECHNICAL FIELD

This description relates to methods and systems for a pipeline control system.

### BACKGROUND

Pipelines are used in the oil and gas industry to transport hydrocarbons from oil fields on land and offshore locations to oil and gas processing facilities, refineries, and distribution and shipping terminals. The pipelines are often buried underground and can be very long. Sometimes they can be 1,000 km in length in total with intermediate pump/compressor stations at typical 50-100 km sections, but it is not uncommon to be less than or greater than these lengths. Some sections of the pipeline are underground and some sections are above ground. In addition, the pipelines are subject to high pressures and temperature variations. The temperature variations cause thermal expansion of the pipeline and stress to the pipeline and the pipeline's connections. Due to these factors, the structural integrity of pipelines can fail, resulting in a pipeline bursting or failing (e.g., cracking, losing pressure, or leaking).

### SUMMARY

The present disclosure describes methods and systems, including computer-implemented methods, computer program products, and computer systems for controlling a pipeline system. Aspects of the subject matter described in this specification may be embodied in methods that include: calculating a rate of flow change per minute in a pipeline of the hydrocarbon production system; determining that the rate of flow change is at least ten percent greater than a predetermined flow change threshold; based on a difference between the rate of flow change and the predetermined flow change threshold, triggering one of a high alarm workflow, a high-high alarm workflow, and a high-high-high alarm workflow; detecting, using the triggered one of the high alarm workflow, the high-high alarm workflow, and the high-high-high alarm workflow, a potential or actual break in the pipeline; and in response, performing a corrective action to avoid the potential break or mitigate the actual break in the pipeline.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, based on the difference, triggering one of the high alarm workflow, the high-high alarm workflow, and the high-high-high alarm workflow involves determining that the difference is less than twenty percent; and in response, triggering the high alarm workflow.

In some implementations, the high alarm workflow includes determining whether a pressure in the pipeline is less than or equal to a pressure emergency shutdown (ESD) value, and detecting, using the triggered one of the high alarm workflow, the high-high alarm workflow, and the high-high-high alarm workflow, the potential or actual break in the pipeline involves in response to determining that the pressure in the pipeline is less than or equal to the pressure ESD value, detecting the potential break in the pipeline.

In some implementations, based on the difference, triggering one of the high alarm workflow, the high-high alarm workflow, and the high-high-high alarm workflow involves determining that the difference is greater than or equal to twenty percent and less than thirty percent; and in response, triggering the high-high alarm workflow.

In some implementations, the high-high alarm workflow involves: determining that a rate of pressure change per minute in the pipeline is a decrease equal to or more than five percent from a predetermined pressure change threshold; in response, determining that a flow in the pipeline is greater than five percent of a line break shutdown value; and in response, determining that a pressure in the pipeline is greater than five percent of a line break shutdown value.

In some implementations, detecting, using the triggered one of the high alarm workflow, the high-high alarm workflow, and the high-high-high alarm workflow, the potential or actual break in the pipeline involves in response to detecting that the pressure in the pipeline is greater than five percent of the line break shutdown value, detecting the potential break in the pipeline.

In some implementations, based on the difference, triggering one of the high alarm workflow, the high-high alarm workflow, and the high-high-high alarm workflow involves determining that the difference is greater than thirty percent; and in response, triggering the high-high-high alarm workflow.

In some implementations, the high-high alarm workflow involves: determining that a rate of pressure change per minute in the pipeline is a decrease equal to or more than five percent from a predetermined pressure change threshold; in response, determining that a flow in the pipeline is greater than five percent of a line break shutdown value; and in response, determining that a pressure in the pipeline is greater than five percent of a line break shutdown value.

In some implementations, detecting, using the triggered one of the high alarm workflow, the high-high alarm workflow, and the high-high-high alarm workflow, the potential or actual break in the pipeline involves in response to detecting that the pressure in the pipeline is greater than five percent of the line break shutdown value, detecting the actual break in the pipeline.

In some implementations, the corrective action involves starting a countdown timer of a predetermined length; and outputting a notification to an operator of the hydrocarbon production system indicating the actual break.

In some implementations, the corrective action involves one or more of causing an export pump shutdown, causing an emergency isolation valve to close, or a causing a plantwide alarm.

The subject matter described in this specification can be implemented to realize one or more of the following advantages. The described methods and system generate multiple levels of pre-alarms based on pipeline flow and pressure conditions. These alarms allow the described methods and systems to proactively detect a potential pipeline break condition before the break actually occurs.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE DRAWINGS

FIG. 1 illustrates a pipeline control system, according to some implementations.

FIG. 2 illustrates a high alarm workflow, according to some implementations.

FIG. 3 illustrates a high-high alarm workflow, according to some implementations.

FIG. 4 illustrates a high-high-high alarm workflow, according to some implementations.

FIG. 5 illustrates an example graphical user interface, according to some implementations.

FIG. 6 illustrates a flowchart of an example method, according to some implementations.

FIG. 7 is a block diagram of an example computer system, according to some implementations of the present disclosure.

### DETAILED DESCRIPTION

Existing hydrocarbon production systems include a pipeline break detection alarm that triggers an alarm in case a pipeline in the system breaks. The alarm detects pipeline breaks based on a high pipeline flow value and a low pipeline pressure value. The values may vary based on site or process condition, and are typically set based on the maximum operating conditions of flow and pressure in the production systems (e.g., design operating conditions of the pipelines). In part because the values are based on maximum operating conditions, the alarm can fail to detect pipeline breaks that occur at conditions below the set values. This may occur when the production systems operate at lower rates than the maximum capacity (e.g., within the operating envelope of the pipelines) or when there is a change in the water cut (e.g., a sudden water cut change inside a pipeline will change the density of total flow, and it will proportionally increase surge pressure contributing pipeline break condition). Moreover, existing alarms are reactive to pipeline breaks and do not proactively avoid breaks. For example, existing alarms can be reactively programmed to protect against a condition that results in a pipeline break only after that condition has occurred.

This disclosure describes methods and systems for providing a pipeline control system. The pipeline control system proactively utilizes flow and pressure data to identify pipeline break symptoms and conditions. Additionally, unlike existing systems, the pipeline control system does not use fixed setting values. Rather, the pipeline control system uses dynamic values and rate of pressure and/or flow changes per specific period, the detailed setting values of which can be defined depending on site conditions or processes. As described in more detail below, the pipeline control system is configured to generate multiple levels of alarms such as a pre-warning alarm (also called “high alarm”), an intermediate alarm (also called “high-high alarm”), and a pipeline break alarm (also called “high-high-high alarm”). Each of these alarms is triggered in response to detecting respective pipeline break conditions or symptoms. Furthermore, the pipeline control system is configured to perform emergency shutdown actions for actual pipeline break condition(s) in order to avoid a potential pipeline or to mitigate a break that has occurred.

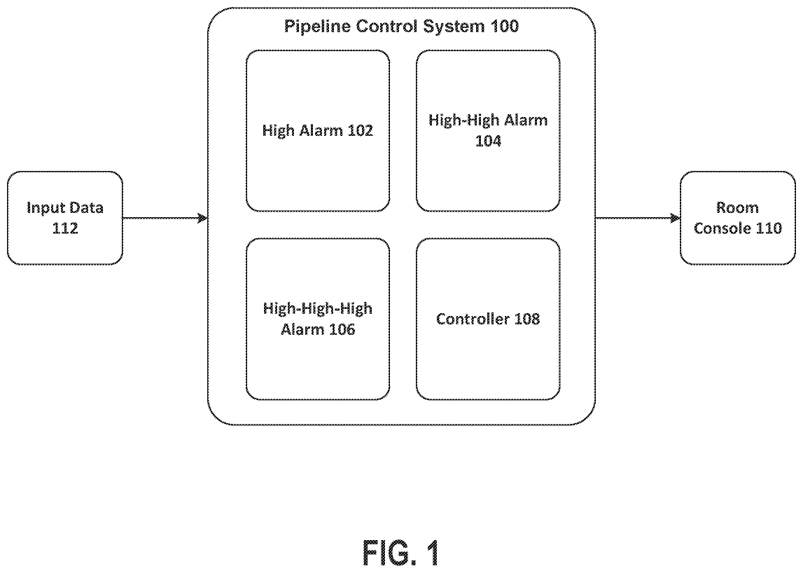

FIG. 1 illustrates a pipeline control system 100, according to some implementations. The pipeline control system 100 includes a high alarm 102, a high-high alarm 104, a high-high-high alarm 106, and a controller 108. The pipeline control system 100 is configured to dynamically detect pipeline breaks, e.g., potential breaks before they occur or actual breaks after they occur. Specifically, the pipeline control system 100 is configured to generate dynamic variables based on historical and measured data. The pipeline control system 100 is configured to detect pipeline breaks based on the dynamic variables. Additionally, the pipeline control system 100 is configured to proactively address a potential pipeline break or respond to an actual pipeline break. In particular, the pipeline control system 100 is configured to control a room console 110 to perform remedial or corrective actions. The room console 110 can be a distributed control system (DCS).

In some implementations, modules of the pipeline control system 100 can be implemented in hardware, software, or both. In some implementations, the term “module” includes software applications/programs or a computer that executes one or more software programs (e.g., program code) that causes the processing unit(s) of the computer to execute one or more functions. The term “computer” is intended to include any data processing device, such as a desktop computer, a laptop computer, a mainframe computer, an electronic notebook device, a computing server, a smart handheld device, or other related device able to process data.

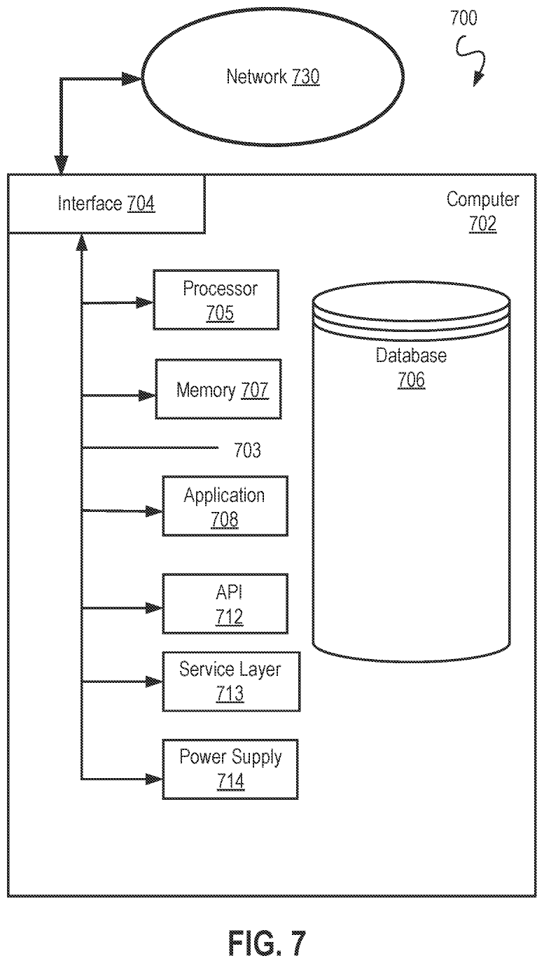

In some implementations, the controller 108 can be implemented in hardware, software, or both. A computing device representing the controller 108 can be a special-purpose hardware integrated circuit, and which includes one or more processor microchips. The computing device can also be included in a computer system 700, which is described later with reference to FIG. 7. The special-purpose circuitry can be used to implement machine-learning algorithms corresponding to learning or inference techniques that are implemented using, for example, neural networks or support vector machines. In general, the computing device can include processors, for example, a central processing unit (CPU) and a graphics-processing unit (GPU), memory, and data storage devices that collectively form one or more computing devices.

In some implementations, the controller 108 is configured to perform automatic acquisition of production data corresponding to input data 112. The input data 112 can include historical and/or measured pressure and hydrocarbon flow data in a hydrocarbon production system that includes pipelines. The hydrocarbon production system can be the same system in which the pipeline control system 100 is implemented or can be similar to the system in which the pipeline control system 100 is implemented. In some implementations, the controller 108 is configured to acquire measured data in real-time. The controller 108 can acquire the data at a dynamic or user-defined rate, such as hourly, daily, or weekly.

In some implementations, the controller 108 is configured generate a rate of change of flow (RCF) threshold and a rate of change of pressure (RCP) threshold. As explained in more detail below, these thresholds can be used for detecting a potential pipeline break or detecting an actual pipeline break. In particular, the controller 108 is configured to generate the RCF threshold and the RCP threshold based on the historical and/or measured pressure and flow data. In an example, the controller 108 is configured to use machine learning to generate the RCF threshold and the RCP threshold. In this example, the controller 108 is configured to generate a machine learning model that is trained using data from a past period. The past period may be specified by a user, determined dynamically, or both. The training data includes values for historical and/or measured pressure and hydrocarbon flow data. In some examples, the training data is data that is selected automatically (e.g., by the controller 108) or manually (e.g., by a user).

In some implementations, the controller 108 is configured to use one or more machine learning algorithms to train the model. Generally, machine-learning can encompass a wide variety of different techniques that are used to train a machine to perform specific tasks without being specifically programmed to perform those tasks. The machine can be trained using different machine-learning techniques, including, for example, supervised learning. In supervised learning, inputs and corresponding outputs of interest are provided to the machine. The machine adjusts its functions in order to provide the desired output when the inputs are provided. Supervised learning is generally used to teach a computer to solve problems in which are outcome determinative. In one example, the machine learning algorithm is the Random Forest algorithm. This algorithm generally accounts for the high variance in reservoir pressure data. However, other example algorithms are also possible.

In some implementations, the trained learning model may be embodied as an artificial neural network. Artificial neural networks (ANNs) or connectionist systems are computing systems inspired by the biological neural networks that constitute animal brains. An ANN is based on a collection of connected units or nodes, called artificial. Each connection, like the synapses in a biological brain, can transmit a signal from one artificial neuron to another. An artificial neuron that receives a signal can process it and then signal additional artificial neurons connected to it. In common ANN implementations, the signal at a connection between artificial neurons is a real number, and the output of each artificial neuron is computed by some non-linear function of the sum of its inputs. The connections between artificial neurons are called ‘edges.’ Artificial neurons and edges may have a weight that adjusts as learning proceeds (for example, each input to an artificial neuron may be separately weighted). The weight increases or decreases the strength of the signal at a connection. Artificial neurons may have a threshold such that the signal is only sent if the aggregate signal crosses that threshold. The transfer functions along the edges usually have a sigmoid shape, but they may also take the form of other non-linear functions, piecewise linear functions, or step functions. Typically, artificial neurons are aggregated into layers. Different layers may perform different kinds of transformations on their inputs. Signals travel from the first layer (the input layer) to the last layer (the output layer), possibly after traversing the layers multiple times.

In some implementations, a plant operation, referred to as “ASL batch operation,” involves periodically (e.g., approximately once a month) diverts a crude export line from an export pipeline to a crude storage tank. During the ASL batch period, the pipeline condition experiences a high rate of changes in flow and pressure conditions. Based on the average values of these rate of changes data, the threshold value for RCF and RCP can be generated using machine learning. In some examples, an additional margin (e.g., 60%) can be applied in real line break case.

Consider as an example a ASL batch operation where the greatest rate of flow change is measured as 17.64%. In this example, the additional margin value is added to rate of flow rate change. As such, the threshold value is 17.64×1.6≈30%. Hence, 30% can be used for the pipeline break condition set point. If a higher rate of change value is detected during another ASL batch, then the newly detected value (plus the predetermined marginal percentage) can be used as pipeline break condition set point. Alternatively, an average of the two values can be used as the value that is added to the predetermined marginal percentage.

In some implementations, the controller 108 is configured to use a new process variable (PV) to calculate a rate of change of flow (RCF) and rate of change of pressure (RCP). In one example, the controller 108 is configured to calculate RCP and RCF on a per minute basis. Hence, in order to calculate RCF and RCP, the following new PVs are used:
CFV=Current Flow Value
PFV=Previous Flow Value (e.g., 1 minute before)
CPV=Current Pressure Value
PPV=Previous Pressure Value (e.g., 1 minute before)

From above, the RCF and RCP can be calculated as follows:

RCF={(CFV−PFV)/CFV}×100(%)

RCP={(PPV−CPV)/CPV}×100(%)

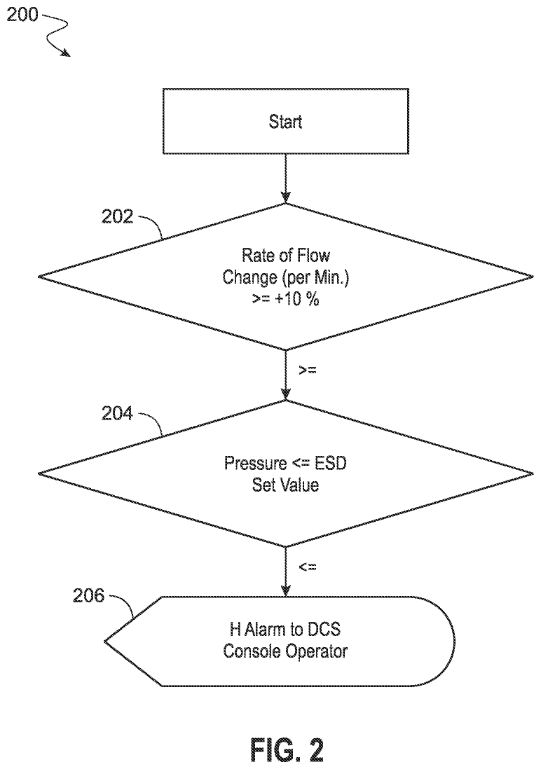

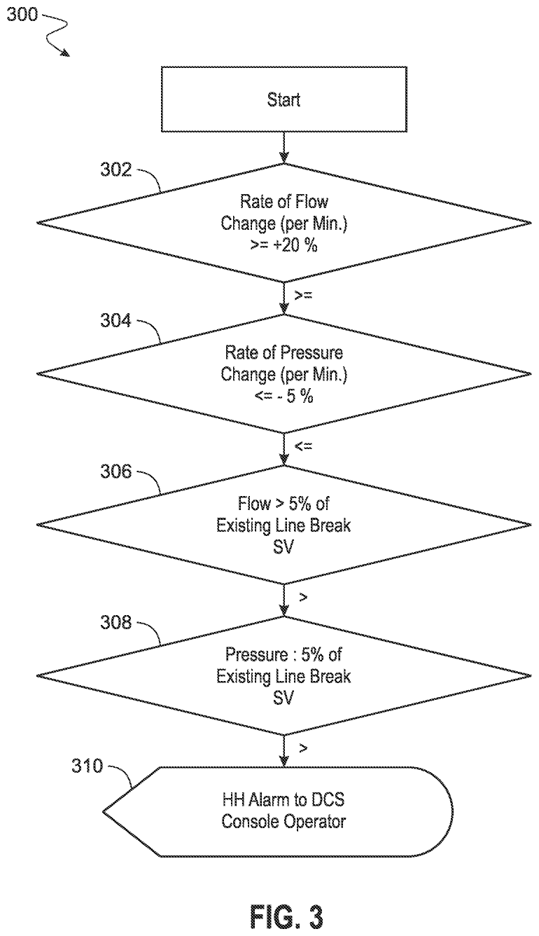

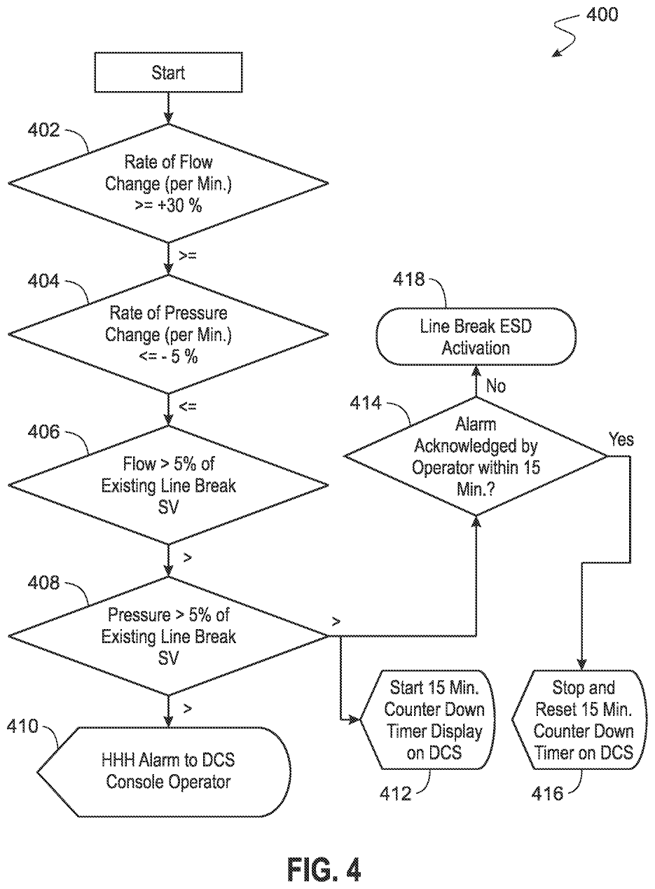

In some implementations, the pipeline control system 100 is configured to use the calculated RCF and RCP to dynamically detect pipeline breaks. More specifically, the high alarm 102, the high-high alarm 104, and the high-high-high alarm 106 monitor the calculated RCF and/or RCP values. Each of the alarms 102-106 is triggered in certain conditions. When an alarm is triggered, that alarm is configured to provide instructions to the controller 108. In some examples, the alarms 102-106 are configured to perform respective workflows for monitoring the RCF and RCP. The workflows also specify actions to be performed based on the monitoring. The workflows are shown in FIGS. 2-4. FIG. 2 illustrates a workflow performed by the high alarm 102, FIG. 3 illustrates a workflow performed by the high-high alarm 104, and FIG. 4 illustrates a workflow performed by the high-high-high alarm 106. In these examples, the RCF and RCP values are percentages. In other examples, the RCF and RCP values can be other fractions, ratios, or other representative values.

FIG. 2 illustrates a high alarm workflow 200, according to some implementations. As shown in step 202, the high alarm 102 monitors the RCF (per minute) to detect if the rate is greater than or equal to a positive 10% difference from the RCF threshold generated by the pipeline control system 100. If that rate is detected, the high alarm 102 moves to step 204. At step 204, the high alarm 102 determines if the pressure value is less than or equal to an existing pressure emergency shutdown (ESD) value. The ESD set value can be determined based on a process simulation during an engineering design of the project. If that pressure value is detected, the high alarm 102 moves to step 206. At step 206, the high alarm 102 controls the room console 110, e.g., by using the controller 108. In an example, the high alarm controls the room console 110 to emit an alarm or other notification. In another example, the high alarm provides a notification to an operator computing device to thoroughly check the pipeline system to see whether or not any abnormal process operation conditions exist.

FIG. 3 illustrates a high-high alarm workflow 300, according to some implementations. As shown in step 302, the high-high alarm 104 monitors the RCF (per minute) to detect if the rate is greater than or equal to a positive 20% difference from the RCF threshold. If that rate is detected, the high-high alarm 104 moves to step 304. At step 304, the high-high alarm 104 determines whether the rate of pressure changes (per minute) is less than or equal to negative 5% from the RCP threshold. If that rate is detected, the high-high alarm 104 moves to step 306. At step 306, the high-high alarm 104 determines whether the flow is greater than 5% of an existing line break flow value. If that flow is detected, the high-high alarm 104 moves to step 308. At step 308, the high-high alarm 104 determines whether the pressure is greater than 5% of existing line break pressure value (e.g., the ESD value). If that pressure is detected, the high-high alarm 104 moves to step 310. At step 310, the high-high alarm 104 controls the room console 110, e.g., by using the controller 108. In an example, the high-high alarm 104 controls the room console 110 to emit an alarm or other notification. In another example, the high-high alarm 104 provides a notification to an operator computing device to thoroughly check the pipeline system to see whether or not any abnormal process operation conditions exist.

FIG. 4 illustrates a high-high-high alarm workflow 400, according to some implementations. At step 402, the high-high-high alarm 106 monitors the rate of flow change (per minute) to detect if the rate is greater than or equal to a positive 30% difference from the RCF threshold. If that rate is detected, the high-high-high alarm 106 moves to step 404. At step 404, the high-high-high alarm 106 determines whether the rate of pressure changes (per minute) is less than or equal to negative 5% from the RCP threshold. If that rate is detected, the high-high-high alarm 106 moves to step 406. At step 406, the high-high-high alarm 106 determines whether the flow is greater than 5% of existing line break flow value. If that flow is detected, the high-high-high alarm 106 moves to step 408. At step 408, the high-high-high alarm 106 determines whether the pressure is greater than 5% of existing line break pressure value. If that pressure is detected, the high-high-high alarm 106 moves to step 410. At step 410, the high-high-high alarm 106 controls the room console 110, e.g., by using the controller 108.

Additionally, as shown by step 412, the controller 108 provides instructions to the room console 110 to start the timer. The length of the timer may be provided by the controller 108 or predetermined. In an example, the timer is 15 minutes. Additionally, the controller 108 provides instructions to the room console 110 to output an alarm on a computing device of an operator. The alarm can be a visual graphic displayed on a display of the computing device, an audible alarm output by a speaker of the computing device, haptic feedback output by the computing device, or any combination of these. In response to the alarm, the high-high-high alarm 106, at step 414, determines whether the operator has acknowledged the alarm before the timer has expired. For example, the operator can either activate pipeline break emergency shutdown system if it is identified as a real pipeline break condition or deactivate the pipeline break action if it is identified as a false alarm. If the operator addresses the alarm, then the high-high-high alarm 106 stops and resets the timer, as shown by step 416. Moreover, if the operator(s) does not address the pipeline break alarm before the timer expires, then the room console 110 will autonomously activate the pipeline break action, as shown by 418. The pipeline break action can include one or more of an Export Pump(s) shutdown, an Emergency Isolation Valve(s) Auto closing, and a Plantwide Alarm.

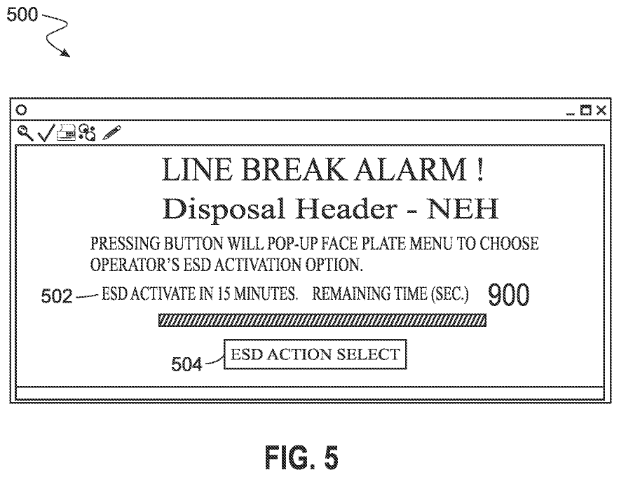

FIG. 5 illustrates an example graphical user interface (GUI) 500, according to some implementations. As shown in FIG. 5, the GUI 500 includes a timer 502 that indicates how much time is remaining from the 15 minute timer. Additionally, the GUI 500 includes a graphical feature 504 (e.g., a button) that, when selected or clicked, provides an operator with a menu that includes a list of ESD actions. The ESD actions can include one or more of an Export Pump(s) shutdown, an Emergency Isolation Valve(s) Auto closing, and a Plantwide Alarm.

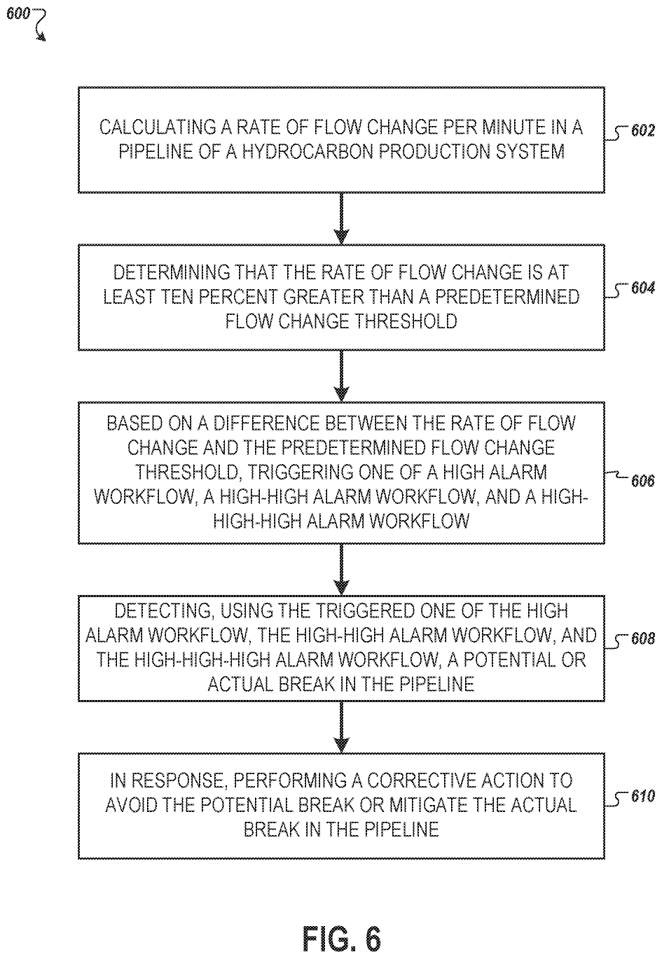

FIG. 6 illustrates a flowchart of an example method 600, according to some implementations. For clarity of presentation, the description that follows generally describes method 600 in the context of the other figures in this description. For example, method 600 can be performed by the pipeline control system 100 FIG. 1. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

At 602, method 600 involves calculating a rate of flow change per minute in a pipeline of a hydrocarbon production system.

At 604, method 600 involves determining that the rate of flow change is at least ten percent greater than a predetermined flow change threshold.

At 606, method 600 involves based on a difference between the rate of flow change and the predetermined flow change threshold, triggering one of a high alarm workflow, a high-high alarm workflow, and a high-high-high alarm workflow.

At 608, method 600 involves detecting, using the triggered one of the high alarm workflow, the high-high alarm workflow, and the high-high-high alarm workflow, a potential or actual break in the pipeline.

At 610, method 600 involves in response, performing a corrective action to avoid the potential break or mitigate the actual break in the pipeline.

In some implementations, based on the difference, triggering one of the high alarm workflow, the high-high alarm workflow, and the high-high-high alarm workflow involves determining that the difference is less than twenty percent; and in response, triggering the high alarm workflow.

In some implementations, the high alarm workflow includes determining whether a pressure in the pipeline is less than or equal to a pressure emergency shutdown (ESD) value, and detecting, using the triggered one of the high alarm workflow, the high-high alarm workflow, and the high-high-high alarm workflow, the potential or actual break in the pipeline involves in response to determining that the pressure in the pipeline is less than or equal to the pressure ESD value, detecting the potential break in the pipeline.

In some implementations, based on the difference, triggering one of the high alarm workflow, the high-high alarm workflow, and the high-high-high alarm workflow involves determining that the difference is greater than or equal to twenty percent and less than thirty percent; and in response, triggering the high-high alarm workflow.

In some implementations, the high-high alarm workflow involves: determining that a rate of pressure change per minute in the pipeline is a decrease equal to or more than five percent from a predetermined pressure change threshold; in response, determining that a flow in the pipeline is greater than five percent of a line break shutdown value; and in response, determining that a pressure in the pipeline is greater than five percent of a line break shutdown value.

In some implementations, detecting, using the triggered one of the high alarm workflow, the high-high alarm workflow, and the high-high-high alarm workflow, the potential or actual break in the pipeline involves in response to detecting that the pressure in the pipeline is greater than five percent of the line break shutdown value, detecting the potential break in the pipeline.

In some implementations, based on the difference, triggering one of the high alarm workflow, the high-high alarm workflow, and the high-high-high alarm workflow involves determining that the difference is greater than thirty percent; and in response, triggering the high-high-high alarm workflow.

In some implementations, the high-high alarm workflow involves: determining that a rate of pressure change per minute in the pipeline is a decrease equal to or more than five percent from a predetermined pressure change threshold; in response, determining that a flow in the pipeline is greater than five percent of a line break shutdown value; and in response, determining that a pressure in the pipeline is greater than five percent of a line break shutdown value.

In some implementations, detecting, using the triggered one of the high alarm workflow, the high-high alarm workflow, and the high-high-high alarm workflow, the potential or actual break in the pipeline involves in response to detecting that the pressure in the pipeline is greater than five percent of the line break shutdown value, detecting the actual break in the pipeline.

In some implementations, the corrective action involves starting a countdown timer of a predetermined length; and outputting a notification to an operator of the hydrocarbon production system indicating the actual break.

In some implementations, the corrective action involves one or more of causing an export pump shutdown, causing an emergency isolation valve to close, or a causing a plantwide alarm.

FIG. 7 is a block diagram of an example computer system 700 that can be used to provide computational functionalities associated with described algorithms, methods, functions, processes, flows, and procedures, according to some implementations of the present disclosure. In some implementations, the pipeline control system 100 can be the computer system 700, include the computer system 700, or the pipeline control system 100 can communicate with the computer system 700.

The illustrated computer 702 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 702 can include a Smart Embedded Management Agent (SEMA), such as a built-in ADLINK SEMA 2.2, and a video sync technology, such as Quick Sync Video technology supported by ADLINK MSDK+. In some examples, the computer 702 can include the MXE-5400 Series processor-based fanless embedded computer by ADLINK, though the computer 702 can take other forms or include other components.

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs 712.

The service layer 713 can provide software services to the computer 702 and other components (whether illustrated or not) that are communicably coupled to the computer 702. The functionality of the computer 702 can be accessible for all service consumers using this service layer 713. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 can include an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and manipulate data to perform the operations of the computer 702, including operations using algorithms, methods, functions, processes, flows, and procedures as described in the present disclosure.

The computer 702 can also include a database 706 that can hold data for the computer 702 and other components connected to the network 730 (whether illustrated or not). For example, database 706 can be an in-memory, conventional, or a database storing data consistent with the present disclosure. In some implementations, the database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

An application 708 can be an algorithmic software engine providing functionality according to particular needs, desires, or particular implementations of the computer 702 and the described functionality. For example, an application 708 can serve as one or more components, modules, or applications 708. Multiple applications 708 can be implemented on the computer 702. Each application 708 can be internal or external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system including computer 702, with each computer 702 communicating over network 730. Further, the terms “client”, “user”, and other appropriate terminology can be used interchangeably without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A method for proactive pipeline break detection in a hydrocarbon production system, the method comprising:
calculating a rate of flow change per minute in a pipeline of the hydrocarbon production system;
determining that the rate of flow change is at least ten percent greater than a predetermined flow change threshold;
based on a difference between the rate of flow change and the predetermined flow change threshold, triggering one of a high alarm workflow, a high-high alarm workflow, and a high-high-high alarm workflow;
detecting, using the triggered one of the high alarm workflow, the high-high alarm workflow, and the high-high-high alarm workflow, a potential or actual break in the pipeline; and
in response, performing a corrective action to avoid the potential break or mitigate the actual break in the pipeline.

2. The method of claim 1, wherein based on the difference, triggering one of the high alarm workflow, the high-high alarm workflow, and the high-high-high alarm workflow comprises:
determining that the difference is less than twenty percent; and
in response, triggering the high alarm workflow.

3. The method of claim 2, wherein the high alarm workflow comprises determining whether a pressure in the pipeline is less than or equal to a pressure emergency shutdown (ESD) value, and wherein detecting, using the triggered one of the high alarm workflow, the high-high alarm workflow, and the high-high-high alarm workflow, the potential or actual break in the pipeline comprises:
in response to determining that the pressure in the pipeline is less than or equal to the pressure ESD value, detecting the potential break in the pipeline.

4. The method of claim 1, wherein based on the difference, triggering one of the high alarm workflow, the high-high alarm workflow, and the high-high-high alarm workflow comprises:
determining that the difference is greater than or equal to twenty percent and less than thirty percent; and
in response, triggering the high-high alarm workflow.

5. The method of claim 4, wherein the high-high alarm workflow comprises:
determining that a rate of pressure change per minute in the pipeline is a decrease equal to or more than five percent from a predetermined pressure change threshold;
in response, determining that a flow in the pipeline is greater than five percent of a line break shutdown value; and
in response, determining that a pressure in the pipeline is greater than five percent of a line break shutdown value.

6. The method of claim 5, wherein detecting, using the triggered one of the high alarm workflow, the high-high alarm workflow, and the high-high-high alarm workflow, the potential or actual break in the pipeline comprises:
in response to detecting that the pressure in the pipeline is greater than five percent of the line break shutdown value, detecting the potential break in the pipeline.

7. The method of claim 1, wherein based on the difference, triggering one of the high alarm workflow, the high-high alarm workflow, and the high-high-high alarm workflow comprises:
determining that the difference is greater than thirty percent; and
in response, triggering the high-high-high alarm workflow.

8. The method of claim 7, wherein the high-high-high alarm workflow comprises:
determining that a rate of pressure change per minute in the pipeline is a decrease equal to or more than five percent from a predetermined pressure change threshold;
in response, determining that a flow in the pipeline is greater than five percent of a line break shutdown value; and
in response, determining that a pressure in the pipeline is greater than five percent of a line break shutdown value.

9. The method of claim 8, wherein detecting, using the triggered one of the high alarm workflow, the high-high alarm workflow, and the high-high-high alarm workflow, the potential or actual break in the pipeline comprises:
in response to detecting that the pressure in the pipeline is greater than five percent of the line break shutdown value, detecting the actual break in the pipeline.

10. The method of claim 9, wherein the corrective action comprises:
starting a countdown timer of a predetermined length; and
outputting a notification to an operator of the hydrocarbon production system indicating the actual break.

11. The method of claim 9, wherein the corrective action comprises one or more of: causing an export pump shutdown, causing an emergency isolation valve to close, or a causing a plantwide alarm.

12. One or more non-transitory computer-readable storage media coupled to one or more processors and having instructions stored thereon which, when executed by the one or more processors, cause the one or more processors to perform operations comprising:
calculating a rate of flow change per minute in a pipeline of the hydrocarbon production system;
determining that the rate of flow change is at least ten percent greater than a predetermined flow change threshold;
based on a difference between the rate of flow change and the predetermined flow change threshold, triggering one of a high alarm workflow, a high-high alarm workflow, and a high-high-high alarm workflow;
detecting, using the triggered one of the high alarm workflow, the high-high alarm workflow, and the high-high-high alarm workflow, a potential or actual break in the pipeline; and
in response, performing a corrective action to avoid the potential break or mitigate the actual break in the pipeline.

13. The one or more non-transitory computer-readable storage media of claim 12, wherein based on the difference, triggering one of the high alarm workflow, the high-high alarm workflow, and the high-high-high alarm workflow comprises:
determining that the difference is less than twenty percent; and
in response, triggering the high alarm workflow.

14. The one or more non-transitory computer-readable storage media of claim 13, wherein the high alarm workflow comprises determining whether a pressure in the pipeline is less than or equal to a pressure emergency shutdown (ESD) value, and wherein detecting, using the triggered one of the high alarm workflow, the high-high alarm workflow, and the high-high-high alarm workflow, the potential or actual break in the pipeline comprises:
in response to determining that the pressure in the pipeline is less than or equal to the pressure ESD value, detecting the potential break in the pipeline.

15. The one or more non-transitory computer-readable storage media of claim 12, wherein based on the difference, triggering one of the high alarm workflow, the high-high alarm workflow, and the high-high-high alarm workflow comprises:
determining that the difference is greater than thirty percent; and
in response, triggering the high-high-high alarm workflow.

16. The one or more non-transitory computer-readable storage media of claim 15, wherein the high-high alarm workflow comprises:
determining that a rate of pressure change per minute in the pipeline is a decrease equal to or more than five percent from a predetermined pressure change threshold;
in response, determining that a flow in the pipeline is greater than five percent of a line break shutdown value; and
in response, determining that a pressure in the pipeline is greater than five percent of a line break shutdown value.

17. The one or more non-transitory computer-readable storage media of claim 16, wherein detecting, using the triggered one of the high alarm workflow, the high-high alarm workflow, and the high-high-high alarm workflow, the potential or actual break in the pipeline comprises:
in response to detecting that the pressure in the pipeline is greater than five percent of the line break shutdown value, detecting the actual break in the pipeline.

18. The one or more non-transitory computer-readable storage media of claim 17, wherein the corrective action comprises:
starting a countdown timer of a predetermined length; and
outputting a notification to an operator of the hydrocarbon production system indicating the actual break.

19. The one or more non-transitory computer-readable storage media of claim 17, wherein the corrective action comprises one or more of: causing an export pump shutdown, causing an emergency isolation valve to close, or a causing a plantwide alarm.

20. A system comprising:
one or more processors configured to perform operations comprising:
calculating a rate of flow change per minute in a pipeline of the hydrocarbon production system;
determining that the rate of flow change is at least ten percent greater than a predetermined flow change threshold;
based on a difference between the rate of flow change and the predetermined flow change threshold, triggering one of a high alarm workflow, a high-high alarm workflow, and a high-high-high alarm workflow;
detecting, using the triggered one of the high alarm workflow, the high-high alarm workflow, and the high-high-high alarm workflow, a potential or actual break in the pipeline; and
in response, performing a corrective action to avoid the potential break or mitigate the actual break in the pipeline.
